(19) United States
(12) Patent Application Publication
(10) Pub. No.: US 2022/0102910 A1
(43) Pub. Date: Mar. 31, 2022

(54) MAGNETIC CIRCUIT FOR MAGNETIC CONNECTOR

(71) Applicant: Apple Inc., Cupertino, CA (US)

(72) Inventors: John C. DiFonzo, Emerald Hills, CA (US); Bradley J. Hamel, Redwood City, CA (US); George Tziviskos, San Jose, CA (US); Hao Zhu, San Jose, CA (US); Jean-Marc Gery, Playa Del Rey, CA (US)

(73) Assignee: Apple Inc., Cupertino, CA (US)

(21) Appl. No.: 17/484,624

(22) Filed: Sep. 24, 2021

Related U.S. Application Data
(63) Continuation-in-part of application No. 17/033,514, filed on Sep. 25, 2020.

(51) Int. Cl. H01R 13/62; H01R 13/24

(52) U.S. Cl. CPC H01R 13/6205; H01R 13/2421

(57) ABSTRACT

Connector inserts having reliable contacts, as well as connector receptacles having improved magnetic circuits for use in electronic devices having a thin form factor. These and other examples can provide connector receptacles that can be easily aligned to an opening in an electronic device, as well as connector inserts and connector receptacles that can be readily manufactured.

### CROSS-REFERENCES TO RELATED APPLICATIONS

This application is a continuation-in-part of U.S. patent application Ser. No. 17/033,514, filed Sep. 25, 2020, which is incorporated by reference.

### BACKGROUND

The number of types of electronic devices that are commercially available has increased tremendously the past few years and the rate of introduction of new devices shows no signs of abating. Devices such as tablet computers, laptop computers, desktop computers, all-in-one computers, cell phones, storage devices, wearable-computing devices, portable media players, navigation systems, monitors, adapters, and others, have become ubiquitous.

Electronic devices can share power and data over cables that can include one or more wires, fiber optic cables, or other conductors. Connector inserts can be located at each end of these cables and can be inserted into connector receptacles in the communicating electronic devices to form pathways for power and data.

A connector insert can have contacts that mate with corresponding contacts in a connector receptacle. These contacts can form portions of electrical paths for data, power, or other types of signals. One type of contact, a spring-loaded contact, can be used in either a connector insert or a connector receptacle. But a spring-loaded contact can have a reduced reliability, particularly if currents for a power supply flow through the spring.

A connector receptacle can be positioned in an opening in an electronic device. In many devices, this opening can be on a side of the electronic device. But these electronic devices are becoming thinner, making such positioning increasing difficult. This difficulty can be particularly exacerbated when the connector receptacle is a magnetic connector. For example, it can be difficult to provide sufficient magnetic force in a thin connector receptacle to reliably hold a corresponding connector insert.

Thus, what is needed are connector inserts having reliable contacts, as well as connector receptacles having improved magnetic circuits for use in electronic devices having a thin form factor.

### SUMMARY

Accordingly, embodiments of the present invention can provide connector inserts having reliable contacts, as well as connector receptacles having improved magnetic circuits for use in electronic devices having a thin form factor. These and other embodiments of the present invention can further provide connector receptacles that can be easily aligned to an opening in an electronic device, as well as connector inserts and connector receptacles that can be readily manufactured.

An illustrative embodiment of the present invention can provide contacts for connector inserts and connector receptacles that are highly reliable. These contacts can be spring-loaded contacts having a contacting portion or plunger biased by a spring or other biasing structure. As contact is made between a spring-loaded contact and a corresponding contact, the biased plunger can be depressed. The spring can thereby apply a force between the plunger and the corresponding contact to form an electrical connection. Current in the electrical connection can flow through the plunger and a barrel or other housing for the plunger that is in contact with the plunger. But in some circumstances, as the plunger is depressed, contact between the plunger and the barrel can be broken. When this happens, current can flow through the spring. If the contact is a power supply contact, the current can damage or destroy the spring thereby rendering the contact and possibly the connector inoperable.

Accordingly, an illustrative embodiment of the present invention can provide spring-biased contacts that include an intermediate object between a plunger and a spring or other biasing structure. The intermediate object can have a first length that is greater than a diameter of a barrel that houses the plunger, spring and intermediate object. The intermediate object can be between a backside of the plunger and the spring, where the intermediate object simultaneously contacts an inside surface of barrel at a first location and a second location. The first location and the second location can be on opposite sides of the intermediate object. The first location can be a first distance from a front opening of the barrel and the second location can be a second distance from the front opening of the barrel, where the first distance is different than the second distance.

In these and other embodiments of the present invention, an inside surface of the barrel can provide a first force along a first vector against the intermediate object at the first location and the inside surface of the barrel can provide a second force along a second vector against the intermediate object at the second location. The first force vector and the second force vector can be parallel and non-overlapping.

The intermediate object can have various shapes. For example, the intermediate object can have a capsule shape. The intermediate object can have a stadium-of-rotation shape. The intermediate object can have a spherocylinder shape. The intermediate object can have a shape defined by two hemispheres separated by a cylinder.

In these and other embodiments of the present invention, an interface between the plunger and the spring can be arranged to provide a force between the intermediate object and the barrel as well as a force between the plunger and the barrel. For example, a backside of the plunger can have a sloped surface. The backside of the plunger can have a conical surface. The backside of the plunger can have an off-center conical surface. The backside of the plunger can have a sloped off-center conical surface. The contact can be one of several contacts in a connector receptacle or connector insert.

These and other embodiments of the present invention can provide a connector system having an improved magnetic circuit This magnetic circuit can provide a magnet array arranged to provide a strong attachment that allows the use of a low profile connector receptacle and connector insert. The magnet array can include magnets and magnetic elements, where the magnetic elements can be magnetically conductive pole-pieces. Each pole piece can have magnets at two or more of its sides. The magnets can be arranged in an alternating manner such that the field lines of the pole pieces provide a strong magnetic attachment to a magnetically conductive attraction plate of a corresponding connector. The magnetic circuit can further include the attraction plate, which can be arranged to be attracted to the magnet array and to fit in a connector that houses the magnet array.

An illustrative embodiment of the present invention can provide a connector receptacle that can be easily aligned with an opening in a device enclosure for an electronic device. The electronic device can include a printed circuit board or other substrate, and can be at least partially housed in a device enclosure. The device enclosure can have an opening. A connector receptacle can be mounted on a portion of the device enclosure, the board, or other substrate. The connector receptacle can be attached to the enclosure or board using brackets. The brackets can be positionable within a housing of the connector receptacle such that the connector receptacle can be positionable within the electronic device in at least one dimension. This can allow the connector receptacle to be aligned with the opening in the device enclosure of the electronic device.

While embodiments of the present invention can provide connector inserts and connector receptacles for delivering power, these and other embodiments of the present invention can be used as connector receptacles in other types of connector systems, such as connector systems that can be used to convey power, data, or both.

In various embodiments of the present invention, contacts, shields, plungers, springs, isolation objects, pistons, barrels, and other conductive portions of a connector receptacle or connector insert can be formed by stamping, metal-injection molding, machining, CNC machining, micro-machining, 3-D printing, or other manufacturing process. The conductive portions can be formed of stainless steel, steel, copper, copper titanium, phosphor bronze, or other material or combination of materials. They can be plated or coated with nickel, gold, or other material. The nonconductive portions, such as housings, locks, pistons, and other structures can be formed using injection or other molding, 3-D printing, machining, or other manufacturing process. The nonconductive portions can be formed of silicon or silicone, rubber, hard rubber, plastic, nylon, liquid-crystal polymers (LCPs), ceramics, or other nonconductive material or combination of materials. The printed circuit boards or other boards used can be formed of FR-4 or other material. The magnets can be permanent magnets formed of recycled rare-earth magnets, other rare-earth magnets, or other magnetic elements.

Embodiments of the present invention can provide connector receptacles and connector inserts that can be located in, and can connect to, various types of devices such as portable computing devices, tablet computers, desktop computers, laptops, all-in-one computers, wearable computing devices, smart phones, storage devices, portable media players, navigation systems, monitors, power supplies, video delivery systems, adapters, remote control devices, chargers, and other devices. These connector receptacles and connector inserts can provide interconnect pathways for signals that are compliant with various standards such as one of the Universal Serial Bus (USB) standards including USB Type-C, High-Definition Multimedia Interface® (HDMI), Digital Visual Interface (DVI), Ethernet, DisplayPort, Thunderbolt™, Lightning™ Joint Test Action Group (JTAG), test-access-port (TAP), Peripheral Component Interconnect express, Directed Automated Random Testing (DART), universal asynchronous receiver/transmitters (UARTs), clock signals, power signals, and other types of standard, non-standard, and proprietary interfaces and combinations thereof that have been developed, are being developed, or will be developed in the future. Other embodiments of the present invention can provide connector receptacles and connector inserts that can be used to provide a reduced set of functions for one or more of these standards. In various embodiments of the present invention, these interconnect paths provided by these connector receptacles and connector inserts can be used to convey power, ground, signals, test points, and other voltage, current, data, or other information.

Various embodiments of the present invention can incorporate one or more of these and the other features described herein. A better understanding of the nature and advantages of the present invention can be gained by reference to the following detailed description and the accompanying drawings.

### BRIEF DESCRIPTION OF THE DRAWINGS

FIG. 1 illustrates an electronic system that can be improved by the incorporation of embodiments of the present invention;

FIG. 2 illustrates a connector receptacle according to an embodiment of the present invention;

FIG. 3 illustrates the connector receptacle of FIG. 2;

FIG. 4 is an exploded view of the connector receptacle of FIG. 2;

FIG. 5 illustrates a cutaway side view of the connector receptacle of FIG. 2;

FIG. 6 illustrates a side view of the connector receptacle of FIG. 2 in a device enclosure according to an embodiment of the present invention;

FIG. 7A and FIG. 7B illustrate portions of the connector receptacle of FIG. 2;

FIG. 8 illustrates a connector insert according to an embodiment of the present invention;

FIG. 9 illustrates a spring-loaded contact according to an embodiment of the present invention;

FIG. 10 illustrates a transparent side view of the spring-loaded contact of FIG. 9;

FIG. 11 illustrates a cutaway side view of the spring-loaded contact of FIG. 9;

FIG. 12 is a more detailed view of an intermediate object that can be used in the spring-loaded contact of FIG. 9;

FIG. 13A and FIG. 13B illustrate an intermediate object according to an embodiment of the present invention;

FIG. 14 is a more detailed view of a plunger for the spring-loaded contact of FIG. 9;

FIG. 15 illustrates another spring-loaded contact according to an embodiment of the present invention;

FIG. 16 is a more detailed view of the spring-loaded contact of FIG. 15;

FIG. 17 illustrates another spring-loaded contact according to an embodiment of the present invention;

FIG. 18A and FIG. 18B illustrate another spring-loaded contact according to an embodiment of the present invention;

FIG. 19 illustrates another spring-loaded contact according to an embodiment of the present invention;

FIG. 20 is an exploded view of the spring-loaded contact of FIG. 19;

FIG. 21 illustrates a magnetic array according to an embodiment of the present invention; and

FIG. 22 illustrates a magnetic circuit according to an embodiment of the present invention.

### DESCRIPTION OF ILLUSTRATIVE EMBODIMENTS

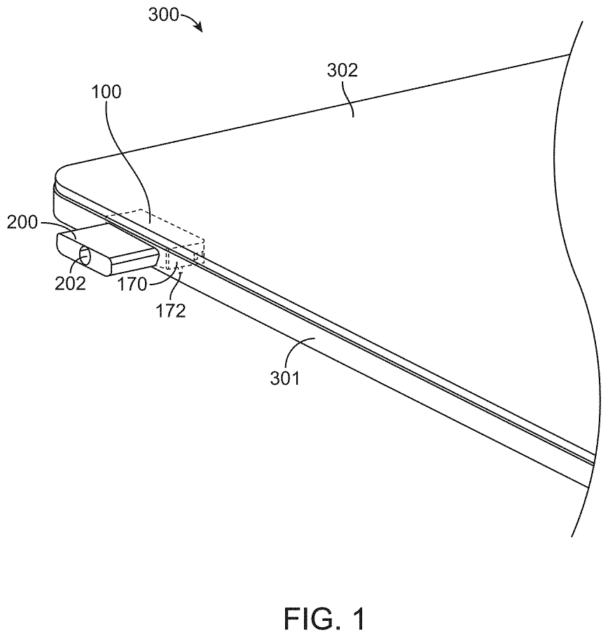

FIG. 1 illustrates an electronic system that can be improved by the incorporation of an embodiment of the present invention. This figure, as with the other included figures, is shown for illustrative purposes and does not limit either the possible embodiments of the present invention or the claims.

This figure illustrates an electronic device 300 including connector receptacle 100. Electronic device 300 can include bottom enclosure 301 encasing connector receptacle 100. Electronic device 300 can further include top enclosure 302 over bottom enclosure 301. Top enclosure 302 can house a screen or monitor, or other electronic components (not shown.) Bottom enclosure 301 can house a keyboard, processor, battery, or other electronic components (not shown.) The electronic components in top enclosure 302 and bottom enclosure 301 can receive and provide power and data using connector receptacle 100. In one example, the electronic components in top enclosure 302 and bottom enclosure 301 can receive power via connector receptacle 100 and can provide data regarding a charging status of a battery of electronic device 300 via connector receptacle 100.

Connector receptacle 100 can include shield 170 having tabs 172. Tabs 172 can be inserted into and soldered to openings (not shown) in a printed circuit board (not shown) in bottom enclosure 301 of electronic device 300. Connector insert 200 can be plugged into or mated with connector receptacle 100. Connector insert 200 can include passage 202 for a cable (not shown.)

In this example, electronic device 300 can be a laptop or portable computer. In these and other embodiments of the present invention, electronic device 300 can instead be another portable computing device, tablet computer, desktop computer, all-in-one computer, wearable-computing device, smart phone, storage device, portable media player, navigation system, monitor, power supply, video delivery system, adapter, remote control device, charger, or other device.

Examples of connector receptacles 100 and connector inserts 200 are shown in the following figures.

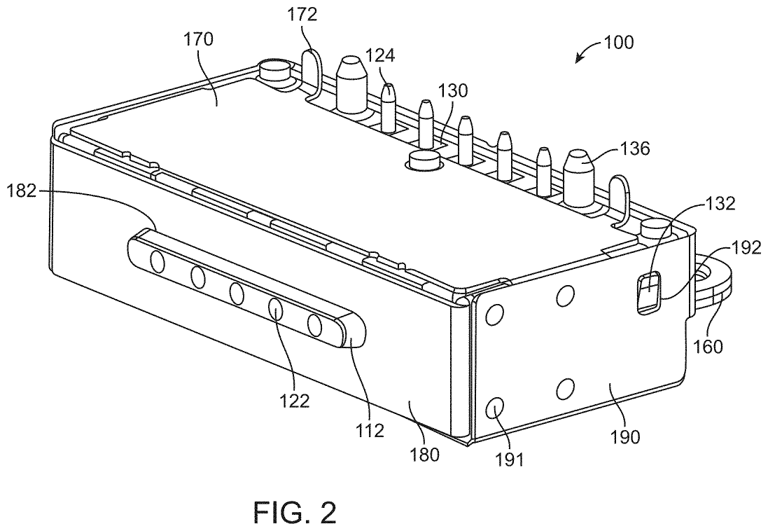

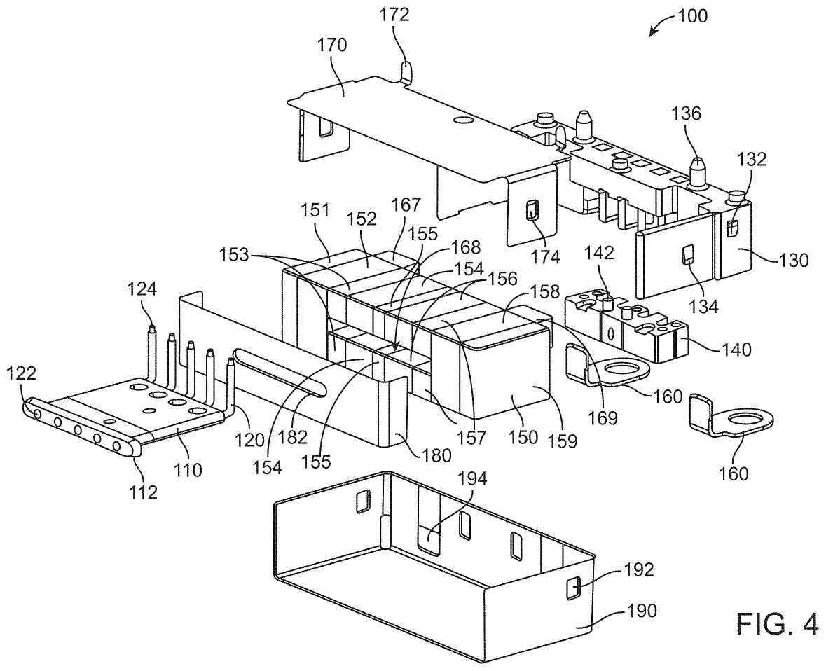

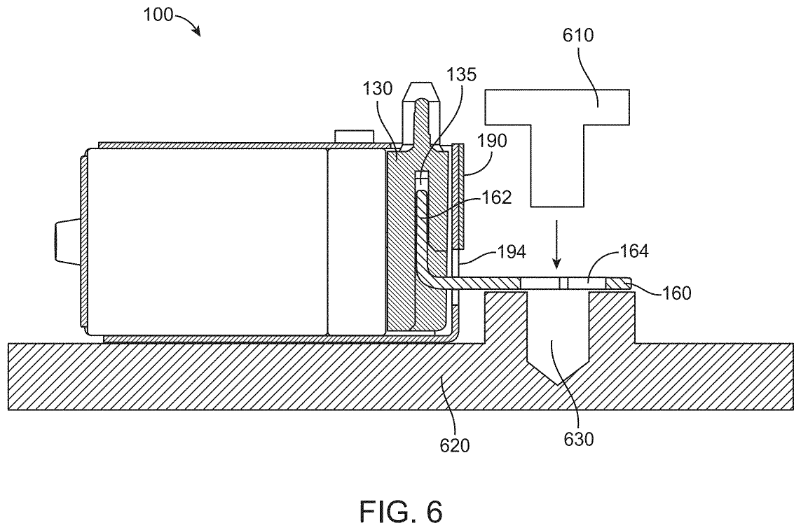

FIG. 2 illustrates a connector receptacle according to an embodiment of the present invention. Connector receptacle 100 can include mesa 112 supporting contacting surfaces 122 of contacts 120 (shown in FIG. 4.) Mesa 112 can emerge through opening 182 in faceplate 180. Contacts 120 can terminate in through-hole contacting portions 124. In these and other embodiments of the present invention, contacts 120 can terminate in surface-mount contacting portions (not shown.) Housing 130 can include posts 136. Shield 170 can include tabs 172. Through-hole contacting portions 124, posts 136, and tabs 172 can be inserted into corresponding openings in a printed circuit board, flexible circuit board, or other appropriate substrate 620 (shown in FIG. 6.) Housing 130 can further include tab 132 that can fit an opening 192 of shield 190. Shield 170 can be attached to shield 190 at points 191 by spot or laser-welding or other technique. Bracket 160 can be used to secure connector receptacle 100 in place in electronic device 300 (shown in FIG. 1) as shown further below.

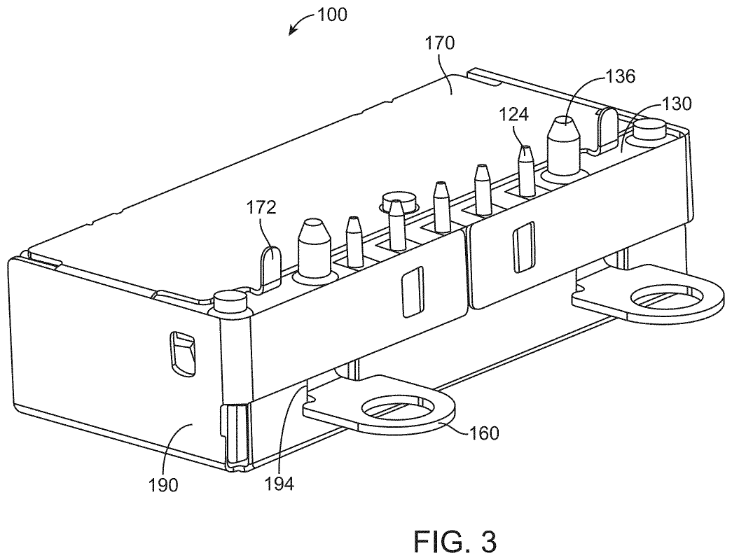

FIG. 3 illustrates the connector receptacle of FIG. 2. Brackets 160 can emerge through the openings 194 in shield 190. Shield 170 can include tabs 172. Contacts 120 (shown in FIG. 4) can terminate in through-hole contacting portions 124. Housing 130 can include posts 136. Through-hole contacting portions 124, posts 136, and tabs 172 can be fit in corresponding openings in a printed circuit board, flexible circuit board, or other appropriate substrate 620 (shown in FIG. 6.) Brackets 160 can be used secure connector receptacle 100 in place in electronic device 300, as shown in FIG. 1.

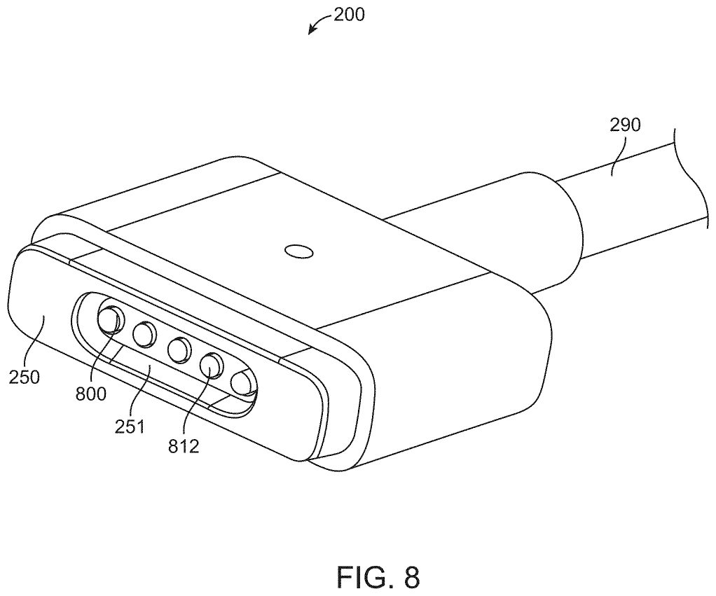

FIG. 4 is an exploded view of the connector receptacle of FIG. 2. Contacts 120 can be supported by contact housing 110. Contact housing 110 can terminate in mesa 112. Contacts 120 can include contacting surfaces 122 on mesa 112 and through-hole contacting portions 124. Mesa 112 can emerge from opening 182 in faceplate 180. Faceplate 180 can protect magnet array 150. Faceplate 180 can be formed of a soft magnetic alloy to optimize the attachment force between magnet array 150 and attraction plate 250 (shown in FIG. 8.) For example, faceplate 180 can be formed of a soft magnetic alloy or other magnetically conductive material, such as stainless steel, low-carbon steel, iron-cobalt, an iron-silicon or nickel-iron alloy, or other ferro-magnetic or ferri-magnetic material.

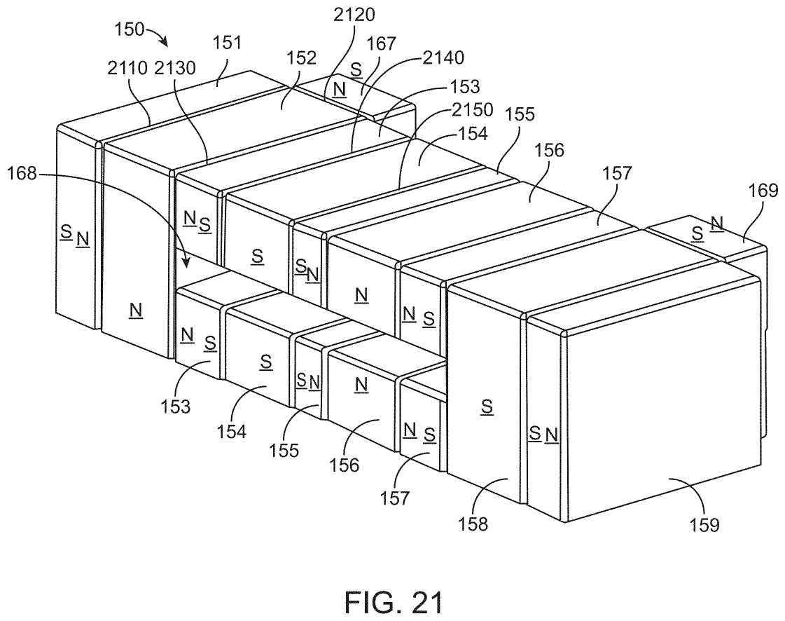

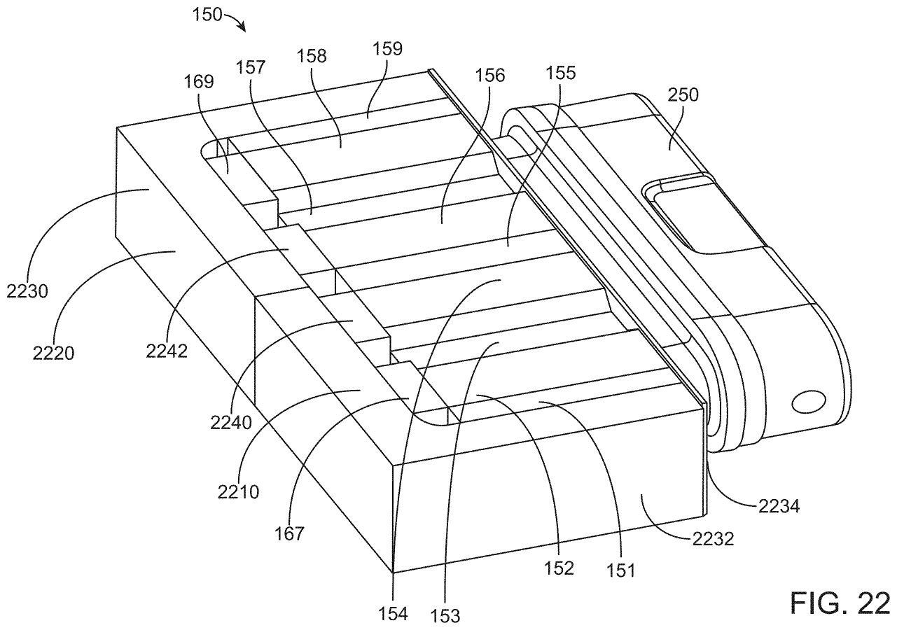

Magnet array 150 can be positioned around contact housing 110. Contact housing 110 can pass through an opening 168 in magnet array 150. Magnet array 150 can include pole piece 152, pole pieces 154, pole pieces 156, and pole piece 158. Magnet array 150 can include magnet 151, magnets 153, magnets 155, magnets 157, and magnet 159. Each of pole piece can be formed of a soft magnetic alloy or other magnetically conductive material, such as stainless steel, low-carbon steel, iron-cobalt, an iron-silicon or nickel-iron alloy, or other ferro-magnetic or ferri-magnetic material. Each of these pole pieces can be abutted by two or more magnets. For example, pole piece 152 can be abutted by magnet 151 and magnets 153. Pole piece 152 can guide a magnet polarity, such as a north magnetic polarity. Accordingly, magnet 151 and magnets 153 can have their north pole adjacent to pole piece 152 and their south pole away from pole piece 152. Pole piece 152, pole pieces 154, pole pieces 156, and pole piece 158 can have alternating polarities. For example, pole piece 152 and pole pieces 156 can pass field lines of a first polarity and pole pieces 154 and pole piece 158 can pass field lines of a second polarity. For example, pole piece 152 and pole pieces 156 can have a north polarity and pole pieces 154 and pole piece 158 can have a south polarity. Alternatively, pole piece 152 and pole pieces 156 can have a south polarity and pole pieces 154 and pole piece 158 can have a north polarity. Additional magnets 167 and 169 can be included in magnet array 150. For example, additional magnet 167 can be adjacent to pole piece 152. In the example where magnet 151 and magnets 153 have their north poles adjacent to pole piece 152, additional magnet 167 can also have its north pole adjacent to pole piece 152 while the south pole of additional magnet 167 can face away from pole piece 152. Additional magnet 167 and additional magnet 169 can further increase a magnetic field conveyed provided at a face of connector receptacle 100. Further details of magnet array 150 can be found in FIG. 21 and FIG. 22 below.

Contact housing 110 can further be supported by housing 130 and lock 140. Contact housing 110 can be positioned between housing 130 and lock 140. Housing 130 can include post 136, tabs 132, and tabs 134. Tab 132 can fit in opening 192 of shield 190. Tab 134 can fit in opening 174 of shield 170. Shield 170 can further include tabs 172. Brackets 160 can fit in openings 194 of shield 190.

It can be desirable to accurately align mesa 112 and contacting surfaces 122 to an opening in bottom enclosure 301 of electronic device 300 (shown in FIG. 1.) Connector receptacle 100 can be positioned on a surface of or associated with bottom enclosure 301. This can help to provide an accurate alignment. However, various manufacturing tolerances can remain. Accordingly, it can be desirable to be able to adjust a connection between connector receptacle 100 and bottom enclosure 301 in at least one direction. An example is shown in the following figure.

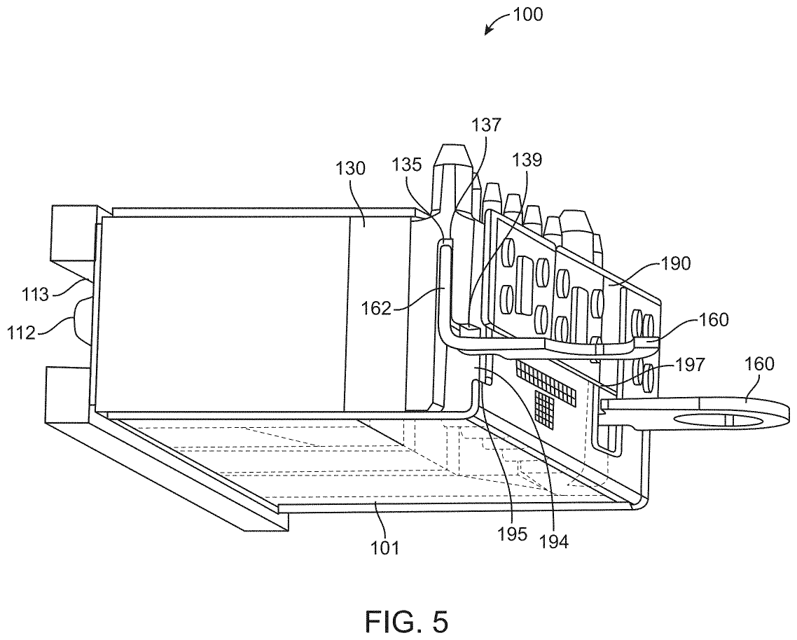

FIG. 5 illustrates a cutaway side view of the connector receptacle of FIG. 2. A bottom surface 101 of connector receptacle 100 can be placed on a printed circuit board, enclosure surface, or other appropriate substrate 620 (shown in FIG. 6.) Brackets 160 can be used to secure connector receptacle 100 to substrate 620. To improve alignment of connector receptacle 100 to an opening in bottom enclosure 301 (shown in FIG. 1), it can be desirable that bracket 160 be able to move in at least one direction relative to the other portions of connector receptacle 100. Accordingly, bracket 160 can be positioned in slot 135 in housing 130. In this way, tab 162 of bracket 160 can slide vertically in slot 135. This can allow bracket 160 to move relative to the remainder of connector receptacle 100 and can allow connector receptacle 100 to be accurately positioned in bottom enclosure 301.

In this example bracket 160 can be capable of moving up board until tab 162 hits a top 137 of slot 135. Also or instead, the upward travel can be limited by an edge 197 at a top of opening 194 in shield 190. Also or instead, the upward travel can be limited by edge 139 of housing 130 engaging bracket 160. Bracket 160 can be capable of moving downward until bracket 160 hits bottom edge 195 of opening 194. This arrangement can allow bracket 160 to move vertically relative to a remaining portion of connector receptacle 100. In this example, mesa 112 can be located in recess 113.

FIG. 6 illustrates a side view of the connector receptacle of FIG. 2 in a device enclosure according to an embodiment of the present invention. In this example, connector receptacle 100 can be mounted on substrate 620. Substrate 620 can be a printed circuit board, portion of bottom enclosure 301 (shown in FIG. 1), or other appropriate substrate. Substrate 620 can include fastener opening 630 to accept fastener 610. Fastener 610 can pass through opening 164 in bracket 160 to secure bracket 160 and connector receptacle 100 to substrate 620. Again, tab 162 of bracket 160 can move vertically in slot 135 of housing 130. Bracket 160 can pass through opening 194 in shield 190.

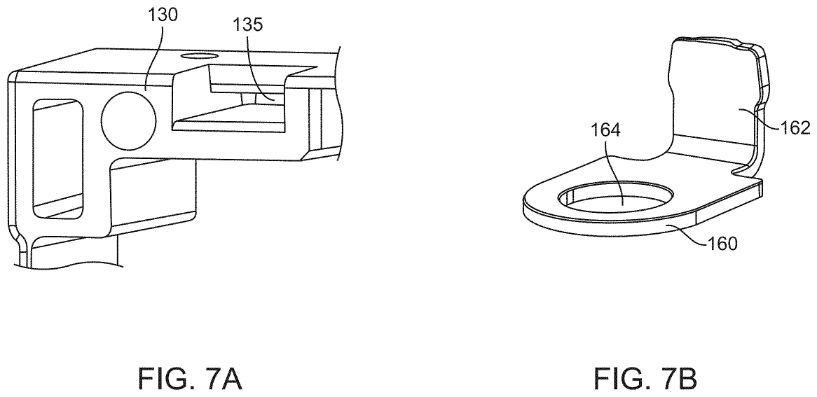

FIG. 7A and FIG. 7B illustrate portions of the connector receptacle of FIG. 2. Housing 130 can include slot 135 for accepting bracket 160. Bracket 160 can include tab 162 and opening 164.

FIG. 8 illustrates a connector insert according to an embodiment of the present invention. Connector insert 200 can be arranged to mate with connector receptacle 100, as shown in FIG. 1. Connector insert 200 can be at a first end of cable 290. Connector insert 200 can include an attraction plate 250 that can be magnetically attracted to magnet array 150 (shown in FIG. 4.) Attraction plate 250 can include opening 251 for accepting mesa 112 (shown in FIG. 2) of connector receptacle 100. Attraction plate 250 can fit in recess 113 of connector receptacle 100 (both shown in FIG. 5.) Contacting surfaces 122 of contacts 120 (shown in FIG. 2) can form electrical connections at contacting surfaces 812 of spring-loaded contacts 800.

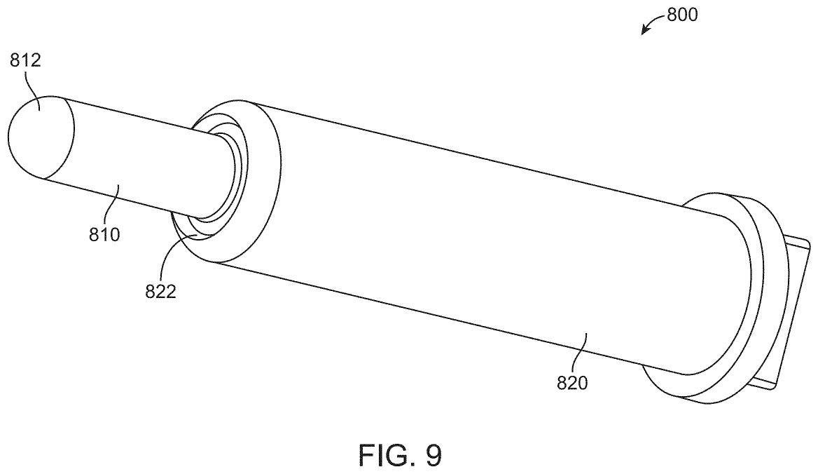

FIG. 9 illustrates a spring-loaded contact according to an embodiment of the present invention. Spring-loaded contact 800 can include plunger 810. Plunger 810 can include contacting surface 812. Plunger 810 can emerge from front opening 822 in barrel 820.

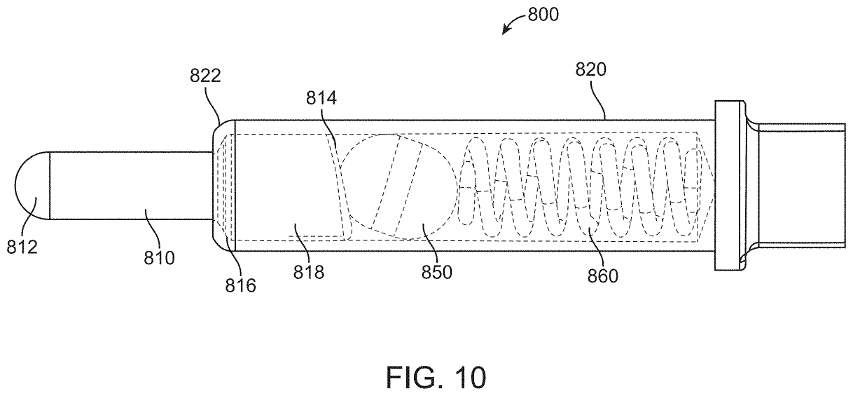

As contact is made between spring-loaded contact 800 and a corresponding contact, such as contacting surface 122 of contact 120 (shown in FIG. 4), the biased plunger 810 can be depressed. Spring 860 (shown in FIG. 10) in spring-loaded contact 800 can apply a force between plunger 810 and the corresponding contact thereby forming an electrical connection. Typically, current in the electrical connection can flow through the plunger and barrel 820. But in some configurations, as plunger 810 is depressed, contact between plunger 810 and the barrel 820 can be broken. In this circumstance, current can flow through spring 860. If spring-loaded contact 800 is a power supply contact, such as a contact providing a power supply voltage or ground, the current can damage or destroy spring 860 thereby rendering the contact inoperable.

Accordingly, an illustrative embodiment of the present invention can provide spring-biased contacts that include an intermediate object between plunger 810 and spring 860 or other biasing structure. Examples are shown in the following figures.

FIG. 10 illustrates a transparent side view of the spring-loaded contact of FIG. 9. Plunger 810 can include contacting surface 812. Plunger 810 can further include neck 816 leading to body 818. Body 818 can be retained inside barrel 820 by front opening 822. Plunger 810 can include backside 814. Backside 814 can contact intermediate object 850. Intermediate object 850 can be positioned between plunger 810 and spring 860. Spring 860 can act to push plunger 810 out of barrel 820 and can be compliant such that plunger 810 can be depressed into barrel 820 of spring-loaded contact 800 when mated with a corresponding contacting surface 122 (shown in FIG. 2.)

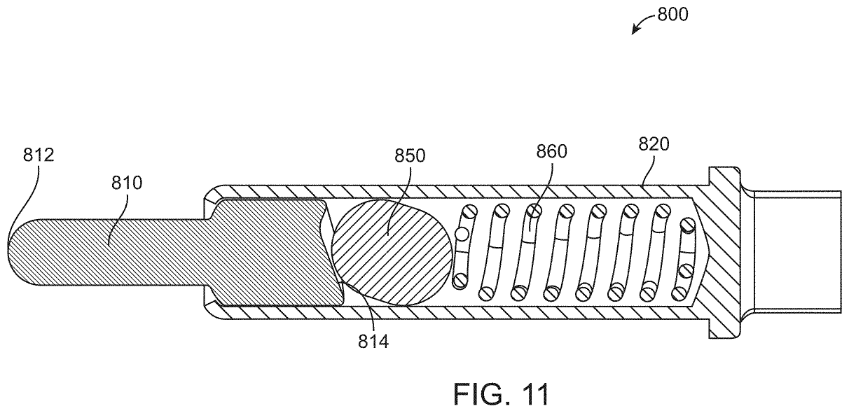

FIG. 11 illustrates a cutaway side view of the spring-loaded contact of FIG. 9. Spring-loaded contact 800 can include intermediate object 850 in barrel 820. Intermediate object 850 can be positioned between plunger 810 and spring 860. Intermediate object 850 can contact backside 814 of plunger 810. Plunger 810 can further have tip or contacting surface 812. Spring 860 can push intermediate object 850 against backside 814 of plunger 810.

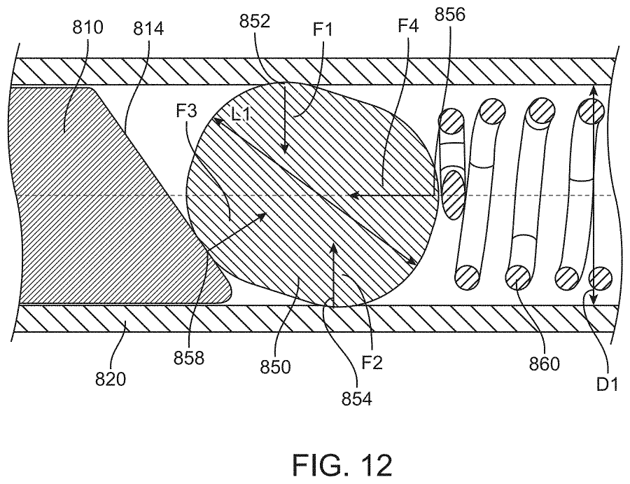

FIG. 12 is a more detailed view of an intermediate object that can be used in the spring-loaded contact of FIG. 9. Intermediate object 850 can be positioned between plunger 810 and spring 860. Intermediate object 850 can encounter backside 814 of plunger 810 as well as spring 860. Intermediate object 850 can provide multiple paths for currents in spring-loaded contact 800. For example, current can flow though plunger 810 into intermediate object 850 and through first location 852 to barrel 820. Current can also flow though plunger 810 into intermediate object 850 and through second location 854 to barrel 820. These current paths can help to limit current through spring 860. The currents in barrel 820 can then flow through other conduits that are connected to barrel 820, such as wires, board traces, or others (not shown.)

Intermediate object 850 can have a first length L1 that is greater than a diameter D1 of barrel 820. Intermediate object 850 can be between a backside 814 of plunger 810 and spring 860, where intermediate object 850 simultaneously contacts an inside surface of barrel at first location 852 and second location 854. First location 852 and second location 854 can be on opposite sides of intermediate object 850. First location 852 can be a first distance (not shown) from front opening 822 of barrel 820 and second location 854 can be a second distance (not shown) from front opening 822, the first distance different than the second distance.

In these and other embodiments of the present invention, an inside surface of barrel 820 can provide a first force along a first force vector F1 against intermediate object 850 at first location 852. The inside surface of barrel 820 can provide a second force along a second force vector F2 against intermediate object 850 at second location 854. The first force vector F1 and the second force vector F2 can be parallel and non-overlapping. Backside 814 of plunger 810 can provide third force vector F3 to intermediate object 850 at location 858. Spring 860 can provide fourth force vector F4 to intermediate object 850 at location 856.

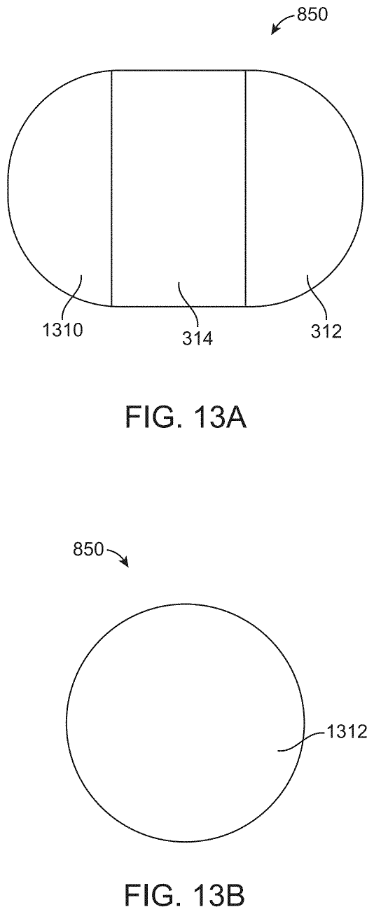

FIG. 13 illustrates an intermediate object according to an embodiment of the present invention. Intermediate object 850 can have various shapes. For example, intermediate object 850 can have a capsule shape. Intermediate object 850 can have a stadium-of-rotation shape. Intermediate object 850 can have a spherocylinder shape. Intermediate object 850 can have a shape defined by two hemispheres 1310 and 1312 separated by cylinder 1314.

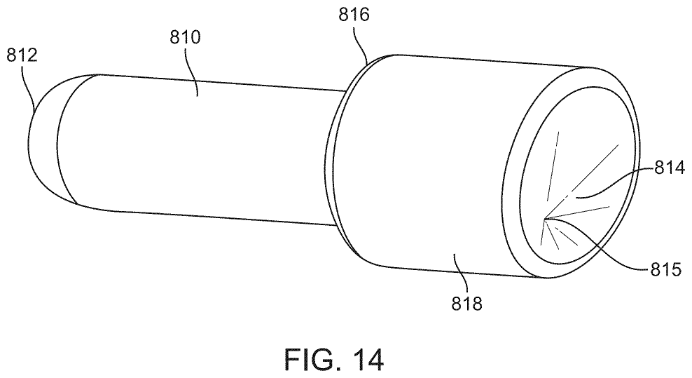

FIG. 14 is a more detailed view of a plunger for the spring-loaded contact of FIG. 9. Plunger 810 can include contacting surface 812. Plunger 810 can further include neck 816 leading to body 818. Plunger 810 can include backside 814. Backside 814 can be sloped. Backside 814 can have a conical indentation. Backside 814 can have a conical surface. Backside 814 can have an off-center conical surface. Backside 814 can have a sloped off-center conical surface. The conical indention can have an apex at point 815. Plunger 810 can be used as the other plungers shown herein or otherwise provided by embodiments of the present invention.

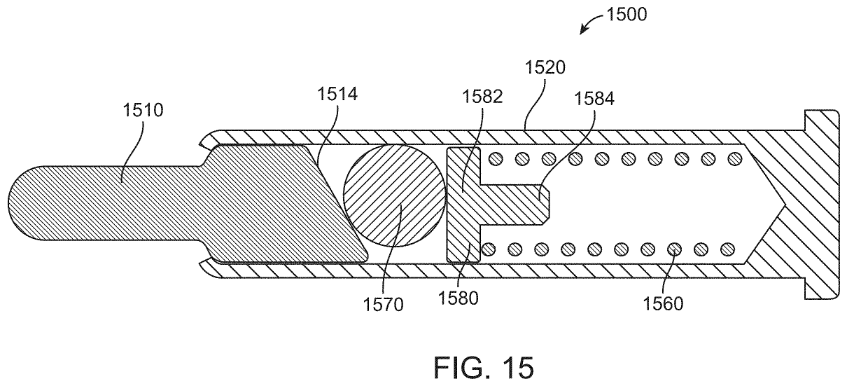

FIG. 15 illustrates another spring-loaded contact according to an embodiment of the present invention. Spring-loaded contact 1500 can be used as spring-loaded contact 800 (shown in FIG. 8.) Spring-loaded contact 1500 can include plunger 1510, intermediate object 1570, piston 1580, and spring 1560. At least a portion of plunger 1510, intermediate object 1570, piston 1580, and spring 1560 can be housed in barrel 1520. Piston 1580 can include head 1582 and tail 1584. Some of spring 1560 can encircle tail 1584 of piston 1580, thereby keeping piston 1580 aligned to spring 1560. Spring 1560 can apply force against head 1582 of piston 1580, thereby pushing head 1582 of piston 1580 into intermediate object 1570. Intermediate object 1570 can push against a backside 1514 of piston 1580. As spring-loaded contact 1500 engages a corresponding contact, such as contacting surface 122 of contacts 120 (shown in FIG. 4), plunger 1510 can be depressed into barrel 1520. This can compress spring 1560. In this way, spring 1560 can continue to apply a force pushing plunger 1510 against contacting surface 122 when the contacts are mated.

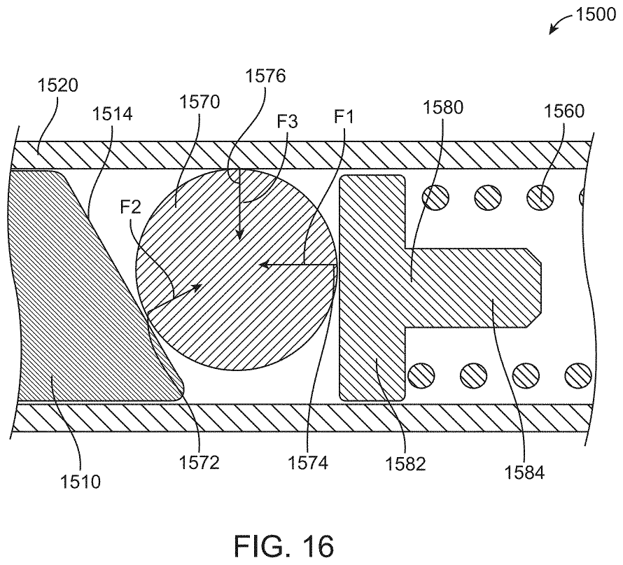

FIG. 16 illustrates a close-up view of a portion of the spring-loaded contact FIG. 15. Spring 1560 can push against head 1582 of piston 1580. Some of spring 1560 can encircle tail 1584 of piston 1580. Spring 1560 can provide force F1 at location 1574 to intermediate object 1570 through head 1582 of piston 1580. This force can be resisted by force F2 applied to location 1572 of intermediate object 1570 by backside 1514 of plunger 1510. These forces can push intermediate object 1570 into barrel 1520 at location 1576 with force F3.

In these and other embodiments of the present invention, intermediate object 1570 can be formed of a conductive material, while piston 1580 can be formed of a nonconductive or insulating material. This arrangement can provide current flow through spring-loaded contact 1500 while protecting spring 1560 from excessive currents. Plunger 1510 can contact intermediate object 1570 at location 1572. Currents can flow through this location through intermediate object 1570 and to barrel 1520 at location 1576. When piston 1580 is nonconductive, current does not flow through intermediate object 1570 to piston 1580 via location 1574. This can protect spring 1560 from seeing excessive current. When piston 1580 is conductive, currents can flow through intermediate object 1570 to piston 1580 via location 1574. Piston 1580 can be can then contact inside surface of barrel 1520 providing and other current path to protect spring 1560.

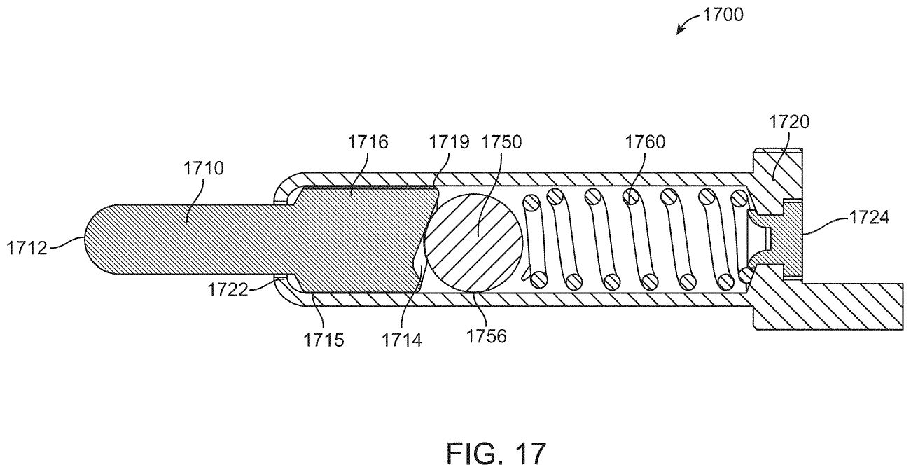

FIG. 17 illustrates another spring-loaded contact according to an embodiment of the present invention. Spring-loaded contact 1700 can be used as spring-loaded contact 800 (shown in FIG. 8.) Spring-loaded contact 1700 can include plunger 1710, intermediate object 1750, and spring 1760. At least portion 1716 of plunger 1710, intermediate object 1750, and spring 1760 can be housed in barrel 1720. Tip 1712 of plunger 1710 can extend beyond opening 1722 of barrel 1720. An end of barrel 1720 can be sealed by seal 1724. Spring 1760 can apply force against intermediate object 1750, thereby pushing intermediate object 1750 against a backside 1714 of plunger 1710. As spring-loaded contact 1700 engages a corresponding contact, such as contacting surface 122 of contacts 120 (shown in FIG. 4), plunger 1710 can be depressed into barrel 1720. This can compress spring 1760. In this way, spring 1760 can continue to apply a force pushing tip 1712 of plunger 1510 against contacting surface 122 when the contacts are mated.

In these and other embodiments of the present invention, intermediate object 1750 can be formed of a conductive material. When spring-loaded contact 1700 is mated with a corresponding contact, plunger 1710 can contact intermediate object 1750 at its backside 1714. Current can flow through plunger 1710 and through this location to intermediate object 1750 and then to barrel 1720 at location 1756. Plunger 1710 can tilt in barrel 1720 making contact with barrel 1720 at location 1715 and location 1719. As a result, current can also flow through plunger 1710 to barrel 1720 at location 1715 and location 1719.

In these and other embodiments of the present invention, backside 1714 of plunger 1710, and the other backsides of the other plungers shown here, can have various contours. For example, they can be flat, sloped, or otherwise curved, they can be conical or have conical indentations or other non-uniform surfaces. Backside 1714 of plunger 1710 can have an off-center conical surface. The backside of the plunger can have a sloped off-center conical surface.

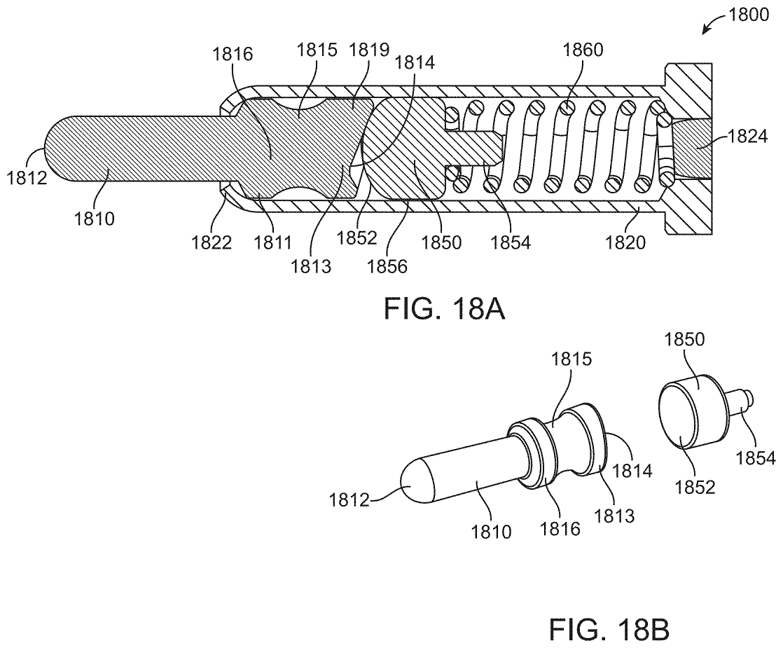

FIG. 18A and FIG. 18B illustrate another spring-loaded contact according to an embodiment of the present invention. Spring-loaded contact 1800 can be used as spring-loaded contact 800 (shown in FIG. 8.) Spring-loaded contact 1800 can include plunger 1810, piston 1850, and spring 1860. At least some of plunger 1810 including wide portion 1816, narrow portion 1815, and wide portion 1813, piston 1850, and spring 1860 can be housed in barrel 1820. Tip 1812 of plunger 1810 can extend through opening 1822 of barrel 1820. Plunger 1810 can include narrow portion 1815 between wide portion 1813 and wide portion 1816. Barrel 1820 can be sealed with seal 1824. Piston 1850 can include head 1852 and tail 1854. Some of spring 1860 can encircle tail 1854 of piston 1850, thereby keeping piston 1850 aligned to spring 1860. Spring 1860 can apply force against head 1852 of piston 1850, thereby pushing head 1852 of piston 1850 into backside 1814 of plunger 1810. As spring-loaded contact 1800 engages a corresponding contact, such as contacting surface 122 of contacts 120 (shown in FIG. 4), plunger 1810 can be depressed into barrel 1820. This can compress spring 1860. In this way, spring 1860 can continue to apply a force pushing tip 1812 of plunger 1810 against contacting surface 122 when the contacts are mated.

In these and other embodiments of the present invention, piston 1850 can be formed of a conductive material. When spring-loaded contact 1800 is mated with a corresponding contact, plunger 1810 can contact piston 1850 at its backside 1814. Current can flow through plunger 1810 and through this location to piston 1850 and to barrel 1820 at location 1856. Plunger 1810 can tilt in barrel 1820 making contact with barrel 1820 at location 1811 of wide portion 1816 and location 1819 of wide portion 1813. As a result, current can also flow through plunger 1810 to barrel 1820 at location 1811 and location 1819. The inclusion of wide portion 1816 and wide portion 1813 can help to improve the connection between plunger 1810 and barrel 1820, thereby reducing an impedance of spring-loaded contact 1800.

In these and other embodiments of the present invention, backside 1814 of plunger 1810, and the other backsides of the other plungers shown here, can have various contours. For example, they can be flat, sloped, or otherwise curved, they can be conical or have conical indentations or other non-uniform surfaces. Backside 1814 of plunger 1810 can have an off-center conical surface. The backside of the plunger can have a sloped off-center conical surface.

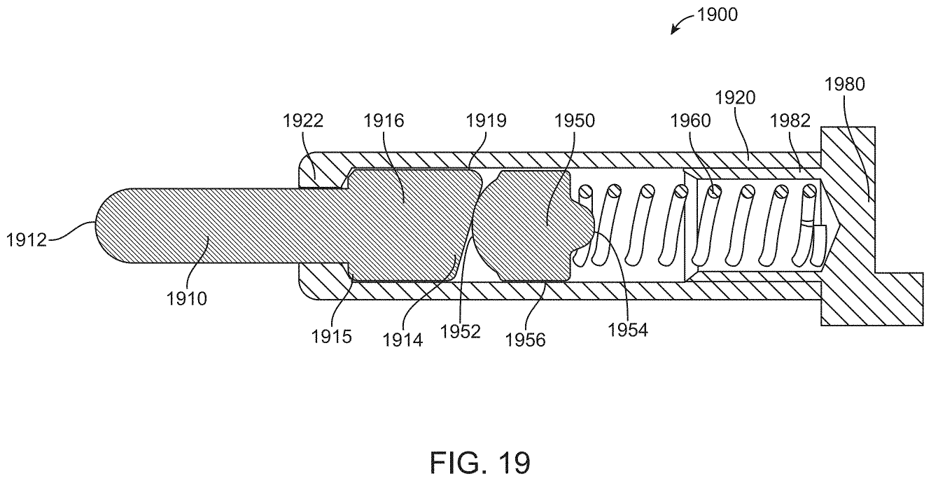

FIG. 19 illustrates another spring-loaded contact according to an embodiment of the present invention. Spring-loaded contact 1900 can be used as spring-loaded contact 800 (shown in FIG. 8.) Spring-loaded contact 1900 can include plunger 1910, piston 1950, and spring 1960. At least a portion 1916 of plunger 1910, piston 1950, and spring 1960 can be housed in barrel 1920. Tip 1912 of plunger 1910 can extend through opening 1922 of barrel 1920. Barrel 1920 can be sealed by back portion 1980. Back portion 1980 can include sleeve 1982 that can fit in barrel 1920. Piston 1950 can include head 1952 and tail 1954. Some of spring 1960 can encircle tail 1954 of piston 1950, thereby keeping piston 1950 aligned to spring 1960. Spring 1960 can apply force against piston 1950, thereby pushing head 1952 of piston 1950 into backside 1914 of plunger 1910. As spring-loaded contact 1900 engages a corresponding contact, such as contacting surface 122 of contacts 120 (shown in FIG. 4), plunger 1910 can be depressed into barrel 1920. This can compress spring 1960. In this way, spring 1960 can continue to apply a force pushing tip 1912 of plunger 1910 against contacting surface 122 when the contacts are mated.

In these and other embodiments of the present invention, piston 1950 can be formed of a conductive material. When spring-loaded contact 1900 is mated with a corresponding contact, plunger 1910 can contact piston 1950 at its backside 1914. Current can flow through plunger 1910 and through this location to piston 1950 and to barrel 1920 at location 1956. Plunger 1910 can tilt in barrel 1920 making contact with barrel 1920 at location 1915 and location 1919 of portion 1916 of plunger 1910. As a result, current can also flow through plunger 1910 to barrel 1920 at location 1911 and location 1919.

In these and other embodiments of the present invention, backside 1914 of plunger 1910, and the other backsides of the other plungers shown here, can have various contours. For example, they can be flat, sloped, or otherwise curved, they can be conical or have conical indentations or other non-uniform surfaces. Backside 1914 of plunger 1910 can have an off-center conical surface. The backside of the plunger can have a sloped off-center conical surface.

While piston 1950 can be conductive, it can still be desirable to protect spring 1960 from current. Accordingly, a portion of piston 1950 can be insulated or nonconductive. An example is shown in the following figure.

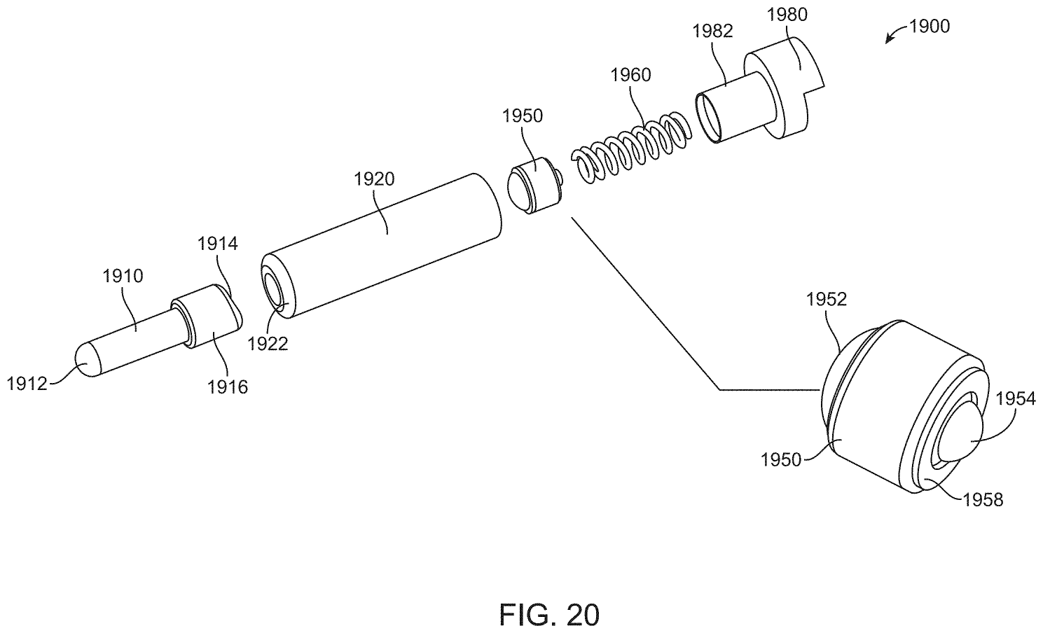

FIG. 20 is an exploded view of the spring-loaded contact of FIG. 19. Spring-loaded contact 1900 can include plunger 1910. Plunger 1910 can include tip 1912, which can extend through opening 1922 of barrel 1920 and portion 1916, which can be housed in barrel 1920. Barrel 1920 can be sealed by back portion 1980. Back portion 1980 can include sleeve 1982, which can be fit inside barrel 1920 and can be fixed in place, for example by soldering or laser or spot-welding. Barrel can house piston 1950. Piston 1950 can include head 1952 that can contact backside 1914 of plunger 1910. Piston 1950 can include tail 1954, which can be partially encircled by spring 1960. Spring 1960 can bias piston 1950 and plunger 1910.

Insulating piece 1958 can help to prevent piston 1950 from electrically contacting spring 1960, thereby protecting spring 1960. Insulating piece 1958 can be tape, molded plastic, or other insulating material. Insulating piece 1958 can be die cut, molded, or formed in other ways.

Connector receptacle 100 (shown in FIG. 4) can be employed in a side surface of electronic device 300 (shown in FIG. 1.) When electronic device 300 is thin or has a low-z height, it can be difficult for connector receptacle 100 to provide enough magnetic hold force to secure connector insert 200 (shown in FIG. 8) in place. Accordingly, these and other embodiments of the present invention can provide a connector system having an improved magnetic circuit This magnetic circuit can provide a magnet array arranged to provide a strong attachment that allows the use of a low profile connector receptacle and connector insert. The magnet array can include magnets and magnetic elements, where the magnetic elements can be magnetically conductive pole-pieces and the magnets can be permanent magnets. Each pole piece can have magnets at two of its sides. The magnets can be arranged in an alternating manner such that the field lines of the pole pieces provide a strong magnetic attachment to a magnetically conductive attraction plate of a connector insert. The magnetic circuit can further include an attraction plate arranged to be attracted to the magnet array and to fit in a connector housing the magnet array. Examples are shown in the following figures.

FIG. 21 illustrates a magnetic array according to an embodiment of the present invention. Magnet array 150 can be positioned around contact housing 110 (shown in FIG. 4.) Contact housing 110 can pass through opening 168 in magnet array 150. Magnet array 150 can include pole piece 152, pole pieces 154, pole pieces 156, and pole piece 158. Magnet array 150 can include magnet 151, magnets 153, magnets 155, magnets 157, and magnet 159. Additional magnets including additional magnet 167 and additional magnet 169 can also be included.

Each pole piece can be abutted by two or more magnets. In general, each pole piece can have magnets at two or more surfaces. Each north pole piece can have magnets oriented with their north pole at a surface of the pole piece and a south pole away from the surface of the pole piece. Each south pole piece can have magnets oriented with their south pole at a surface of the pole piece and a north pole away from the surface of the pole piece. For example, pole piece 152 can be abutted by magnet 151 and magnets 153. Pole piece 152 can guide a magnet polarity, such as a north magnetic polarity. Accordingly, magnet 151 and magnets 153 can have their north pole adjacent to pole piece 152 and their south pole away from pole piece 152. More specifically, pole piece 152 can have magnet 151 at first surface 2110 and magnets 153 at second surface 2130, where first surface 2110 and second surface 2130 are opposing surfaces. Pole piece 152 can further have additional magnet 167 at third surface 2120, where third surface 2120 is adjacent to first surface 2110 and adjacent to second surface 2130. Each pole piece 154 can have a magnet 155 at a fourth surface 2140 and a magnet 155 at a fifth surface 2150, where fourth surface 2140 and fifth surface 2150 are opposing surfaces. The remaining pole pieces may be configured in a similar manner.

Pole piece 152, pole pieces 154, pole pieces 156, and pole piece 158 can have alternating polarities. For example, pole piece 152 and pole pieces 156 can pass field lines of a first polarity and pole pieces 154 and pole piece 158 can pass field lines of a second polarity. For example, pole piece 152 and pole pieces 156 can have a north polarity and pole pieces 154 and pole piece 158 can have a south polarity. Alternatively, pole piece 152 and pole pieces 156 can have a south polarity and pole pieces 154 and pole piece 158 can have a north polarity. Additional magnets 167 and 169 can be included. For example, additional magnet 167 can be adjacent to pole piece 152. In the example where magnet 151 and magnets 153 have their north poles adjacent to pole piece 152, additional magnet 167 can also have its north pole adjacent to pole piece 152 while the south pole of additional magnet 167 can face away from pole piece 152. Additional magnet 167 and additional magnet 169 can further increase a magnetic field conveyed provided at a face of connector receptacle 100.

Each pole piece, such as pole piece 152, pole pieces 154, pole pieces 158, and pole piece 158, as well as magnetic element 2210 and magnetic element 2212 (both shown in FIG. 22) and faceplate 180 (shown in FIG. 4) can be formed of a magnetically conductive material, for example, a soft magnetic alloy or other magnetically conductive material, such as stainless steel, low-carbon steel, iron-cobalt, an iron-silicon or nickel-iron alloy, or other ferro-magnetic or ferri-magnetic material, or other type of material. Each magnet, such as magnet 151, magnets 153, magnets 155, magnets 157, and magnet 159, as well as additional magnets including additional magnet 167, additional magnet 169, additional magnets 2240 and additional magnets 2242 (both shown in FIG. 22) can be a permanent magnet formed of recycled rare-earth magnets, or other rare-earth or other ferro-magnetic material, such as neodymium, neodymium iron boron or nickel-cobalt, or other material.

FIG. 22 illustrates a magnetic circuit according to an embodiment of the present invention. In this example, magnetic flux generated by magnet array 150 can be guided by one or more magnetic element. In this example, the magnetic flux generated by magnet array 150 can be guided by magnetic element 2210 and magnetic element 2220. In these and other embodiments, magnetic element 2210 and magnetic element 2220 can be combined into a single magnetic element, or separated into still further magnetic elements. Magnetic element 2210 and magnetic element 2220 can be positioned along a backside 2230 of magnet array 150 and to the sides 2232 of magnet array 150. These or other magnetic elements can be positioned above or below magnet array 150, or they can be omitted to reduce a thickness of the magnetic circuit. Magnetic element 2210 and magnetic element 2220 can guide field lines of magnetic flux from magnet array 150 to attraction plate 250. That is, magnetic element 2210 and magnetic element 2220 can concentrate the magnetic flux of magnet array 150 into attraction plate 250. Contacting surfaces 122 of contacts 120 (both shown in FIG. 4) can be available at a front 2234 of magnet array 150 to form electrical connections with contacting surfaces 812 in opening 251 (both shown in FIG. 8) of attraction plate 250 of connector insert 200 (shown in FIG. 8.)

In this configuration, magnet 151, magnets 153, magnets 155, magnets 157, and magnet 159 can be positioned to provide flux into pole piece 152, pole pieces 154, pole pieces 156, and pole piece 158 instead of the attraction plate or other magnets. The interface between each magnet and pole piece, such as first surface 2110 (shown in FIG. 21) can be increased in area, as can the thickness of each magnet. Strong rare-earth magnets can be used to further increase the flux provided by magnet array 150, thereby increasing the magnetic attraction between magnet array 150 and attraction plate 250.

Additional magnets including additional magnet 167 and additional magnet 169 can also be included at surfaces of pole piece 152 and pole piece 158. Further additional magnets including additional magnets 2240 and additional magnets 2242 can be included at surfaces of pole pieces 154 and pole pieces 156. These, along with magnet element 2210 and magnetic element 2220 can reduce the reluctance of the magnetic circuit.

Magnetic element 2210 and magnetic element 2220 can be formed of various materials. For example, magnetic element 2210 and magnetic element 2220 can be formed of a soft magnetic alloy or other magnetically conductive material, such as stainless steel, low-carbon steel, iron-cobalt, an iron-silicon or nickel-iron alloy, or other ferro-magnetic or ferri-magnetic material, or other type of material.

The configuration of this magnetic circuit including magnet array 150 can vary in these and other embodiments of the present invention. For example, attraction plate 250 can be formed of a pole-piece and magnet assembly similar to magnet array 150. Different numbers of pole pieces and magnets can be used. For example, one, two, or more than two permanent magnets can be used. Additional magnet 167, additional magnet 169, additional magnets 2240 and additional magnets 2242 can be included or omitted, as can magnetic element 2210 and magnetic element 2220. Also, the relative thickness and dimensions of the pole pieces and magnets can vary. For example, pole piece 154 and pole piece 156 can be narrower or shorter than magnets 153, magnets 155, and magnets 157. Alternatively, magnets 153, magnets 155, and magnets 157 can be narrower or shorter than pole piece 154 and pole piece 156. The same can be true for pole piece 152 and pole piece 158 as compared to magnet 151 and magnet 159.

While embodiments of the present invention can provide connector inserts and connector receptacles for delivering power, these and other embodiments of the present invention can be used as connector receptacles in other types of connector systems, such as connector systems that can be used to convey power, data, or both.

In various embodiments of the present invention, contacts, shields, plungers, springs, pistons, isolation objects, barrels, and other conductive portions of a connector receptacle or connector insert can be formed by stamping, metal-injection molding, machining, micro-machining, CNC machining, 3-D printing, or other manufacturing process. The conductive portions can be formed of stainless steel, steel, copper, copper titanium, phosphor bronze, or other material or combination of materials. They can be plated or coated with nickel, gold, or other material. The springs can be coated with parylene. The nonconductive portions, such as housings, locks, pistons, and other structures can be formed using injection or other molding, 3-D printing, machining, or other manufacturing process. The nonconductive portions can be formed of silicon or silicone, rubber, hard rubber, plastic, nylon, liquid-crystal polymers (LCPs), ceramics, or other nonconductive material or combination of materials. The printed circuit boards or other boards used can be formed of FR-4 or other material.

Embodiments of the present invention can provide connector receptacles and connector inserts that can be located in, and can connect to, various types of devices such as portable computing devices, tablet computers, desktop computers, laptops, all-in-one computers, wearable computing devices, smart phones, storage devices, portable media players, navigation systems, monitors, power supplies, video delivery systems, adapters, remote control devices, chargers, and other devices. These connector receptacles and connector inserts can provide interconnect pathways for signals that are compliant with various standards such as one of the Universal Serial Bus (USB) standards including USB Type-C, High-Definition Multimedia Interface® (HDMI), Digital Visual Interface (DVI), Ethernet, DisplayPort, Thunderbolt™, Lightning™ Joint Test Action Group (JTAG), test-access-port (TAP), Peripheral Component Interconnect express, Directed Automated Random Testing (DART), universal asynchronous receiver/transmitters (UARTs), clock signals, power signals, and other types of standard, non-standard, and proprietary interfaces and combinations thereof that have been developed, are being developed, or will be developed in the future. Other embodiments of the present invention can provide connector receptacles and connector inserts that can be used to provide a reduced set of functions for one or more of these standards. In various embodiments of the present invention, these interconnect paths provided by these connector receptacles and connector inserts can be used to convey power, ground, signals, test points, and other voltage, current, data, or other information.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The above description of embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated. Thus, it will be appreciated that the invention is intended to cover all modifications and equivalents within the scope of the following claims.

What is claimed is:

1. A spring-loaded contact comprising:
a barrel having a front opening;
a plunger having a tip extending through the front opening and a body housed in the barrel;
a spring housed in the barrel; and
an intermediate object between a backside of the plunger and the spring, where the intermediate object simultaneously contacts an inside surface of the barrel at a first location and a second location, the first location and the second location on opposite sides of the intermediate object, and
wherein the first location is a first distance from the front opening and the second location is a second distance from the front opening, the first distance different than the second distance.

2. The spring-loaded contact of claim 1 wherein the intermediate object has a capsule shape.

3. The spring-loaded contact of claim 1 wherein the intermediate object has a stadium-of-rotation shape.

4. The spring-loaded contact of claim 1 wherein the intermediate object has a spherocylinder shape.

5. The spring-loaded contact of claim 1 wherein the intermediate object has a shape defined by two hemispheres separated by a cylinder.

6. The spring-loaded contact of claim 1 wherein the first location is a first distance from the front opening and the second location is a second distance from the front opening, the first distance different than the second distance.

7. The spring-loaded contact of claim 1 wherein the inside surface of the barrel provides a first force along a first force vector against the intermediate object at the first location and the inside surface of the barrel provides a second force along a second force vector against the intermediate object at the second location, and wherein the first force vector and the second force vector are parallel and non-overlapping.

8. The spring-loaded contact of claim 1 wherein the intermediate object has a first length and the barrel has a first diameter, and wherein the first length is greater than the first diameter.

9. A connector comprising:
a magnet array comprising:
a plurality of pole pieces; and
a plurality of magnets spaced apart from one another and separated by the plurality of pole pieces,
wherein each pole piece is adjacent to two magnets in the plurality of magnets;
a first plurality of contacts having contacting portions at a front side of the magnet array; and
a magnetic element along a back side of the magnet array, and further along a first side and a second side of the magnet array, the first side opposite the second side, the first side and the second side adjacent to the back side.

10. The connector of claim 9 wherein for each of the plurality of pole pieces, the pole piece is between and adjacent to two magnets in the plurality of magnets, wherein the two magnets have the same of either a north pole or a south pole facing the pole piece.

11. The connector of claim 10 wherein the magnet array has a central passage and wherein the first plurality of contacts pass through the central passage.

12. The connector of claim 10 wherein the magnet array is arranged as a ring and wherein the first plurality of contacts pass through the center of the ring.

13. The connector of claim 11 wherein the magnet array comprises a first pole piece having a first magnet at a first surface and a second magnet at a second surface, the first surface adjacent to the second surface; and
a second pole piece having a third magnet at a first surface and a fourth magnet at a second surface, the first surface opposite the second surface.

14. The connector of claim 13 wherein the first plurality of contacts are arranged as a line of contacts, the first pole piece is at a first side of the line of contacts and the second pole piece is below the line of contacts.

15. A connector system comprising a magnetic circuit, the magnetic circuit comprising:
a magnet array comprising:
a plurality of pole pieces; and
a plurality of magnets spaced apart from one another and separated by the plurality of pole pieces,
wherein each pole piece is adjacent to two magnets in the plurality of magnets;
a magnetic element along a back side of the magnet array, and further along a first side and a second side of the magnet array, the first side opposite the second side, the first side and the second side adjacent to the back side; and
an attraction plate.

16. The connector system of claim 15 wherein for each of the plurality of pole pieces, the pole piece is between and adjacent to two magnets in the plurality of magnets, wherein the two magnets have the same of either a north pole or a south pole facing the pole piece.

17. The connector system of claim 16 wherein the magnet array and the magnetic element are housed in a connector receptacle and the attraction plate forms a face of a connector insert.

18. The connector system of claim 17 wherein the connector receptacle comprises a first plurality of contacts and wherein the magnet array has a central passage and the first plurality of contacts pass through the central passage.

19. The connector system of claim 18 wherein the connector insert comprises a second plurality of contacts, the second plurality of contacts to mate with the first plurality of contacts, wherein each of the second plurality of contacts comprises:
a barrel having a front opening;
a plunger having a tip extending through the front opening and a body housed in the barrel;
a spring housed in the barrel; and
an intermediate object between a backside of the plunger and the spring, where the intermediate object simultaneously contacts an inside surface of barrel at a first location and a second location, the first location and the second location on opposite sides of the intermediate object.

20. The connector system of claim 19 wherein the intermediate object has a capsule shape.
